(19) United States
(12) Patent Application Publication
(10) Pub. No.: US 2026/0194726 A1
(43) Pub. Date: Jul. 9, 2026

(54) WATER SWELLABLE TAPE FOR USE WITH FIBER OPTIC CABLES

(71) Applicant: Scapa Tapes North America ULC, Renfrew (CA)

(72) Inventors: Simon Terry, Renfrew (CA); Cameron Williams, Renfrew (CA); Juan Penagos, Renfrew (CA)

(21) Appl. No.: 19/440,808

(22) Filed: Jan. 6, 2026

Related U.S. Application Data
(60) Provisional application No. 63/742,034, filed on Jan. 6, 2025.

(51) Int. Cl. G02B 6/44; B01J 20/28; B32B 5/02; B32B 5/26; B32B 7/12; D04H 1/407; D04H 1/44; D04H 1/593

(52) U.S. Cl. CPC G02B 6/44384; B01J 20/28004; B01J 20/28016; B32B 5/022; B32B 5/267; B32B 7/12; D04H 1/407; D04H 1/44; D04H 1/593; B32B 2250/02; B32B 2250/20; B32B 2262/0261; B32B 2262/0276; B32B 2307/72; B32B 2405/00; D10B 2505/00

(57) ABSTRACT

Water swellable materials are provided herein. The materials may be incorporated into a tape or cable wrapping for various conductors, including power, telecom, and fiber optic cables. A water swellable tape comprises first and second polymer layers each comprising a nonwoven material and a water swellable layer positioned between the first and second polymer layers. The polymer layers may each comprise nonwoven fibers chemically bonded to each other and carded to form a softer, thicker web that provides an increased buffer layer to serve as protection for cables, such as ribbon cables and the like. The nonwoven material may comprise a chemical binder selected to have relatively low friction and high heat resistance, thereby reducing the amount of fiber and powder buildup on the extrusion tooling during the manufacturing process, which reduces rework and downtime, thereby decreasing the overall cost to manufacture the cables.

### CROSS-REFERENCE TO RELATED APPLICATIONS

This application claims the benefit of U.S. Provisional Application Ser. No. 63/742,034, filed Jan. 6, 2025, the complete disclosure of which is incorporated herein by reference for all purposes.

### BACKGROUND

Water swellable, also referred to as water blocking, tapes are designed to protect power, telecom, and fiber optic cables from the damaging and corrosive effects of water penetration and migration. When water enters into a cable protected by a water swellable tape, the super-absorbent component within the tape rapidly absorbs the water and quickly swells to block any further ingress. This minimizes and localizes any cable damage due to water and to aid in repair.

In the field of fiber optic cables, a class of cables exist referred to as ribbon cables. These cables require a water blocking tape as a cushion layer and centering layer. The tape is applied longitudinally inside a co-extruded tube over the fiber bundle. The tape must have properties that cushion the fiber from pressure points and must also act as a water blocking element in the event the cable is damaged in service. In production of the cable, the tape is subjected to mechanical friction and high temperatures. These conditions can result in the tape causing a buildup of fiber and powder on the extrusion tooling. This material buildup can break free causing a mechanical blockage of the tooling and/or a cable break or defect, which requires rework. The current manufacturing practice is to stop and clean the tooling between runs. This increases downtime of the manufacturing process, thereby increasing the overall cost to manufacture the cables.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Water swellable materials are provided herein. The materials may be incorporated into a tape or cable wrapping for various conductors, including power, telecom, and fiber optic cables.

In one aspect, a water swellable tape comprises first and second polymer layers each comprising a nonwoven material and a water swellable layer positioned between the first and second polymer layers.

In embodiments, the polymer layers each comprise nonwoven fibers chemically bonded to each other and carded to form a web having a thickness of about 0.1 mm to about 1.0 mm, or about 0.2 mm to about 0.5 mm, or about 0.22 mm to about 0.36 mm. The thickness is measured according to ISO 9073-2 when the polymer layers are completely dry (i.e., the water swellable layer is not in contact with water). The polymer layers may have an area density (i.e., mass per unit area in the width and length of the material) of about 30 g/m² to about 50 g/m², or about 39 g/m² to about 45 g/m². Thus, the overall volumetric density of the polymer layers is reduced, which allows the polymer layers to remain fluffy because the fibers are not permanently compressed during the manufacturing process. The thicker, softer polymer layers provide an increased buffer layer which, in certain embodiments, may serve as protection for cables, such as ribbon cables and the like.

The nonwoven fibers may be selected from any suitable material, such as polyester, nylon or the like. In an exemplary embodiment, the fibers comprise polyester. The fibers may be crimped mechanically to facilitate carding and to increase their thickness and/or fluffiness in the Z-direction, thereby reducing surface contact and friction.

In embodiments, the nonwoven material further comprises a chemical binder selected to have relatively low friction and high heat resistance. This reduces the amount of fiber and powder buildup on the extrusion tooling during the manufacturing process, which reduces rework and downtime, thereby decreasing the overall cost to manufacture the cables. In an exemplary embodiment, the chemical binder comprises a thermoset material, such as polyurethane, polyester, epoxy, silicone, melamine, polyimide, cyanoacrylate phenol resins and the like. The binder may be crosslinked.

In other embodiments, the nonwoven material comprises spun bond and/or wet laid polyester cloth with no binder. In an exemplary embodiment, the polyester cloth is thermoplastic.

The fibers may be continuous or stable fibers. In an exemplary embodiment, the fibers are staples fibers and may have a length of about 30 mm to about 50 mm, or about 35 mm to about 40 mm. The fibers may have a linear density of about 0.5 denier to about 2.0 denier or about 1.0 denier to about 1.5 denier. In certain embodiments, the fibers may be selected to have a machine direction (MD) orientation of about 70% to about 95% or about 80% to about 90%.

In various embodiments, the water swellable layer comprises superabsorbent polymer (SAP) particles, such as crystals, powder, grains, or other granulated material. The SAP particles may comprise any suitable material that swells upon contact with water and compress to fill the polyester layers and form a water seal. Suitable SAP materials include, for example, water borne solutions of acrylate polymers and prepolymers formed from water soluble monomers such as acrylic, meth acrylic acid, and 2-acrylamide (DAA) 2-methylpropanesulfuric acid. Other co-monomers such as acrylamide and N-isopropyl acrylamide can also be incorporated into the SAP. In an exemplary embodiment, the particles comprise a cross-linked sodium acrylate polymer that may be, for example, in the form of powder

In embodiments, the SAP particles have a maximum dimension of less than about 160 microns, or about 75 microns to about 160 microns. In embodiments, the SAP particles are formed through suspension polymerization to create substantially smooth outer surfaces, which reduces signal loss that may otherwise occur with non-smooth surfaces. In an exemplary embodiment, the SAP particles are substantially round or spherical.

The tape further comprises an adhesive configured to bond the first polymer layer to the second polymer layer. The adhesive may comprise any suitable adhesive, preferably one that is water soluble such that the polymer layers release from each other and spread apart when the tape swells upon contact with water. Suitable water soluble adhesives may comprise starch, dextrin, acrylic, polychloroprene, animal or vegetable glues, polyurethane, polymer acetates, such as polyvinyl acetate (PVA) and ethylene vinyl acetate (EVA), polyethylene oxide (PEO), latex, elastomers, rubbers and combinations thereof.

In another aspect, a cable is provided comprising the tape described above. The cable may, for example, comprise a fiber optic ribbon cable having a bundle of optical fibers. The tape substantially surrounds the bundle of fibers and provides a water blocking layer between the fibers and other layers positioned around the tape.

In various embodiments, the cable comprises an outer jacket, an extruded buffer tube and a water swellable tape as described above. The water swellable tape is constructed such that the buffer tube has an ovality of less than about 2.0 mm, or less than about 1.0 mm. Ovality is defined herein as the difference between the maximum diameter and the minimum diameter of the tape. The relatively low ovality of the tube reduces the pressure applied to the fiber optic cables, particularly in the corners of fiber optic bundles that have a rectangular or square configuration. Reducing the pressure applied by the tube to the fiber optic bundles causes a reduction in the signal loss of the individual optic fibers.

In another aspect, a fiber optic cable is provided. The cable comprises a bundle of optical fibers and a water blocking or swellable tape substantially surrounding the optical fibers. The tape comprises first and second polymer layers each comprising a nonwoven polyester material and a water swellable layer positioned between the first and second polymer layers. The tape further comprises a water soluble adhesive positioned between the first and second polymer layers.

It is to be understood that both the foregoing general description and the following detailed description are exemplary and explanatory only and are not restrictive. Additional features will be set forth in part in the description which follows or may be learned by practice of the description.

### BRIEF DESCRIPTION OF THE DRAWINGS

The accompanying drawings, which are incorporated in and constitute a part of this specification, illustrate several embodiments, and serve to explain the principles herein.

FIG. 1 schematically depicts a cross-sectional view of a water swellable tape;

FIG. 2 schematically depicts a cross-sectional view of an exemplary optical fiber cable with the tape of FIG. 1;

FIG. 3 is a partial cut-a-way view of a representative fiber optic ribbon cable;

FIG. 4 is a cross-sectional view of the cable of FIG. 3; and

FIG. 5 is partial cut-a-way view of another representative fiber optic ribbon cable.

### DETAILED DESCRIPTION

This description and the accompanying drawings illustrate exemplary embodiments and should not be taken as limiting, with the claims defining the scope of the description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

In accordance with one aspect of this description, a water swellable or blocking material is provided. The water swellable material may be incorporated into a tape or cable wrapping for various conductors, including power, telecom, and fiber optic cables. In an exemplary embodiment, water swellable tapes are provided for use with fiber optic ribbon cables.

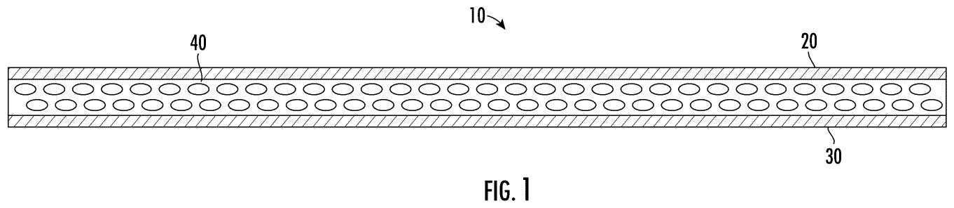

Referring to FIG. 1, a water swellable tape 10 comprises first and second polymer layers 20, 30 and a water swellable material 40 therebetween. Tape 10 further comprises an adhesive (not shown) for bonding layers 20, 30 together. The adhesive may be positioned in contact with layers 20, 30 and/or within water swellable material 40.

Polymer layers 20, 30 preferably comprise a nonwoven material which may comprise a substrate, sheet, layer, film, web, or other media comprising fibers, preferably comprising a material that substantially retains water swellable material 40 within layers 20, 30 when the material swells up on contact with water. The nonwoven material may comprise a structure of individual fibers or threads that are interlaid, interlocked, or bonded together. Nonwoven fabrics may include sheets or web structures bonded together by entangling fiber or filaments (and by perforating films) mechanically, thermally, or chemically. They may be substantially flat, porous sheets that are made directly from separate fibers or molten plastic or plastic film.

The fibers may be manufactured by any suitable method, including, without limitation, meltblown, bicomponent meltblown, spunbond or spunlace, bicomponent spunbond, heat-bonded, carded, air-through bonded carded, air-laid, wet-laid, extrusion, co-formed, needlepunched, stitched, hydraulically entangled or the like.

In an exemplary embodiment, the polymer layers 20, 30 comprise nonwoven fibers chemically bonded to each other and carded to form a web having a thickness of about 0.1 mm to about 1.0 mm, or about 0.2 mm to about 0.5 mm, or about 0.22 mm to about 0.36 mm. The thickness is measured according to ISO 9073-2 when the polymer layers 20, 30 are completely dry (i.e., the water swellable layer is not in contact with water). The polymer layers may have an area density or mass per unit area of about 30 g/m² to about 50 g/m², or about 39 g/m² to about 45 g/m². Thus, the overall volumetric density of the polymer layers is reduced. This design allows the polymer layers to remain fluffy because the fibers are not permanently compressed during the manufacturing process. The thicker, softer polymer layers provide an increased buffer layer which, in certain embodiments, may serve as protection for cables, such as ribbon cables and the like.

The fibers contemplated may have any suitable shape in cross-section, including without limitation, circular, kidney bean, dog bone, trilobal, barbell, bowtie, star, Y-shaped, triangular, multilobal, square, oval and others. These shapes and/or other conventional shapes may be used with any of the embodiments described herein to obtain the desired performance characteristics.

The nonwoven fibers may be selected from any suitable material, such as polyester, nylon or the like. In an exemplary embodiment, the fibers comprise polyester. The fibers may be crimped mechanically to facilitate carding and to increase their thickness or fluffiness in the Z-direction.

In embodiments, the nonwoven material further comprises a chemical binder selected to have relatively low friction and high heat resistance. This reduces the amount of fiber and powder buildup on the extrusion tooling during the manufacturing process, which reduces rework and downtime, thereby decreasing the overall cost to manufacture the cables. In an exemplary embodiment, the chemical binder comprises a thermoset material, such as polyurethane, polyester, epoxy, silicone, melamine, polyimide, cyanoacrylate phenol resins and the like. The binder may be crosslinked.

In other embodiments, the nonwoven material comprises spun bond and/or wet laid polyester cloth with no binder. In an exemplary embodiment, the polyester cloth is thermoplastic.

The tape further comprises an adhesive in contact with the first and second polymer layers. The adhesive functions to bond first polymer layer 20 to second polymer layer 30 and may comprise any suitable adhesive, preferably one that is water soluble such that the polymer layers release from each other and spread apart when the tape swells upon contact with water. Suitable water soluble adhesives may comprise starch, dextrin, acrylic, polychloroprene, animal or vegetable glues, polyurethane, polymer acetates, such as polyvinyl acetate (PVA) and ethylene vinyl acetate (EVA), polyethylene oxide (PEO), latex, elastomers, rubbers and combinations thereof.

In an exemplary embodiment, the adhesive comprises polyethylene oxide. Polyethylene oxide may be used to provide a strong bond to polymer layers 20, 30 when layer 40 is dry or not in contact with a liquid, such as water. In addition, this adhesive will substantially dissolve in water and release the bond between layers 20, 30 when water penetrates into tape 10. This allows water swellable layer 40 to expand and drive polymer layers 20, 30 apart to increase the overall thickness of tape 10 and retain the water therein. The PEO may comprise powders (instead of a coating), which enhances the flexibility of the tape.

The polyester fibers may be continuous or stable fibers. In an exemplary embodiment, the fibers are staples fibers and may have a length of about 30 mm to about 50 mm, or about 35 mm to about 40 mm.

The fibers may be monocomponent or multicomponent fibers. The multicomponent fibers may have any suitable configuration such as concentric core/sheath, eccentric core/sheath, side by side, segmented pie, segmented cross, segmented ribbon, island in the sea, hollow bicomponent fiber. hollow segmented pie, trilobal, tipped multilobal, mixed fibers, striped fibers, conductive fibers, and combinations thereof. In an exemplary embodiment, the fibers are monocomponent fibers.

The fibers may have thicknesses that are suitable for the application. In some embodiments, the fibers have a linear density of about 0.5 denier to about 2.0 denier or about 1.0 denier to about 1.5 denier. In certain embodiments, the fibers may be selected to have a machine direction (MD) orientation of about 70% to about 95% or about 80% to about 90%.

In various embodiments, the fibers may include additives such as other polymers, nucleating agents, plasticizer, slip additives, elastomeric polymers and the like.

Water swellable material 40 preferably comprises a superabsorbent polymer (SAP). SAPs are a class of polymers that are able to absorb large amount of water. Generally speaking, SAPs consist of a network of cross-linked polymer chains that diffuse water within the polymer network where it is stored. The type and degree of crosslinking governs the ability of the superabsorbent polymer to absorb and retain a large volume of water. Examples of suitable superabsorbent polymers are water borne solutions of acrylate polymers and prepolymers formed from water soluble monomers such as acrylic, meth acrylic acid, and 2-acrylamide (DAA) 2-methylpropanesulfuric acid. Other co-monomers such as acrylamide and N-isopropyl acrylamide can also be incorporated into the SAP. Examples of cross-linkers include a variety of multifunctional monomers. They can be di- , tri- , or tetrafunctional, and can have mixed type of polymerizable groups such as methacrylate.

According to one embodiment, the crosslinked superabsorbent polymeric matrix is a cross-linked sodium acrylate polymer that may be, for example, in the form of particles, such as crystals, powder or another granulated substance. In embodiments, the SAP particles have a maximum dimension of less than about 160 microns, or about 75 microns to about 160 microns. In embodiments, the SAP particles are formed through suspension polymerization to create substantially smooth outer surfaces, which reduces signal loss that may otherwise occur with non-smooth surfaces. In an exemplary embodiment, the SAP particles are substantially round or spherical.

In another embodiment, the SAP particles may comprise cross-linked sodium acrylate polymer formed by applying a water-based sodium acrylate polymer or pre-polymer (i.e., liquid SAP) to a substrate and curing by application of heat. When cured, the acrylate polymer or pre-polymer undergoes chemical crosslinking to form the crosslinked superabsorbent polymeric matrix. Suitable water borne solutions of acrylate polymers include Aquaswell 50, Aquaswell 75, and Aquaswell 100, commercially available from H&R ChemPharm (UK) Ltd. (Tipton, West Midlands, United Kingdom). Suitable crosslinked superabsorbent polymers formed on a substrate can also have a binding effect. In one particular embodiment, the liquid SAP may be provided in two parts and mixed prior to use, in order to improve stability in large amounts.

In an alternative embodiment, the water swellable material 40 may be formed as a composite of water-swellable material, fibers, and a water-soluble binder. For example, the material may include water-swellable particulate powder (e.g., SAP powder) and strength-enhancing fibers (e.g., wood pulp) held together with (e.g., embedded. within) a water-soluble binder, such as a polymeric resin (e.g., methyl cellulose resin). Alternative water-soluble binders include polyvinyl alcohol, hydroxyethyl cellulose, ethyl cellulose, cellulose ethers, and latex. In the presence of water, the water-soluble binder will dissolve thereby facilitating the transport of water toward the water-swellable particulate powder. The strength-enhancing fibers within the composite water swellable tape help to ensure that the composite water swellable tape has sufficient strength and structural integrity in the absence of water.

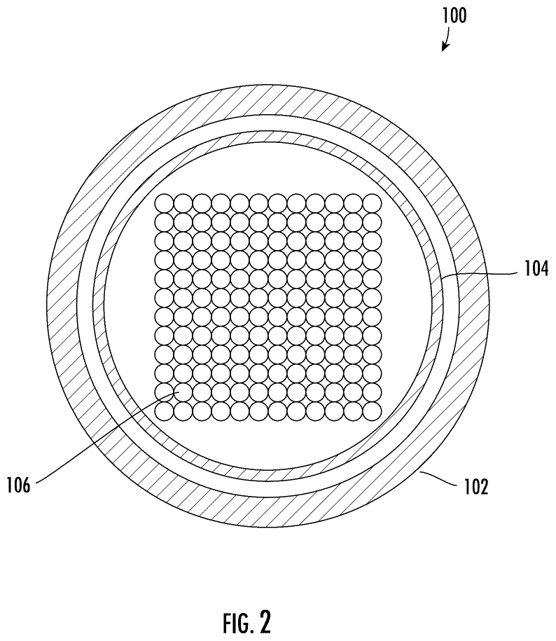

Referring now to FIG. 2, a portion of a cable, such as a fiber optic ribbon cable 100 includes a buffer tube 102, a water swellable tape 104 as described above, and a bundle of fiber optic ribbon cables 106 disposed within tape 104. Ribbon cables 106 may contain conventional glass fibers or bend-insensitive glass fibers. Ribbon cables 106 may include one or more coating layers (e.g., a primary coating and a secondary coating). At least one of the coating layers, typically the secondary coating, may be colored and/or possess other markings to help identify individual fibers. Alternatively, a tertiary ink layer may surround the primary and secondary coatings

Ribbon cables 106 are typically provided in a bundle and form rows of ribbon cables 106 that may have a substantially square, circular, oval, trapezoidal or rectangular cross-section. In this embodiment, the bundle of ribbon cables is substantially rectangular. Multiple optical fibers may be sandwiched, encapsulated, and/or edge bonded to form an optical-fiber ribbon. Optical fiber ribbons can be divisible into subunits (e.g., a twelve fiber ribbon that is splitable into six-fiber subunits). Moreover, a plurality of such optical-fiber ribbons may be aggregated to form a ribbon stack, which can have various sizes and shapes. A rectangular ribbon stack may be formed with or without a central twist (i.e., a “primary twist’). Those having ordinary skill in the art will appreciate that a ribbon stack is typically manufactured with rotational twist to allow the tube or cable to bend without placing excessive mechanical stress on the optical fibers during winding, installation, and use. In a structural variation, a twisted (or untwisted) rectangular ribbon stack may be further formed into a coil-like configuration (e.g., a helix) or a wave-like configuration (e.g., a sinusoid). In other words, the ribbon stack may possess regular ‘secondary deformations.

Tape 104 at least partially encloses optical fibers 106 and preferably completely encloses optical fibers 106. In some embodiments, tape 104 may be in contact with some of the fibers 106 within the bundle, such as the fibers located on the corners of bundle 106. In other embodiments, tape 104 may be spaced from the bundle of fibers 106. Tube 102 surrounds tape 104, although it is contemplated in certain tubeless cable designs that the cable's outer protective jacket (i.e., sheath) surrounds tape 104 with no intermediate buffer tube located between tape 104 and the cable jacket. In certain embodiments, tape 104 may be bonded to the ribbon cables 106 with an adhesive.

The water swellable tape is constructed such that the buffer tube 102 has an ovality of less than about 2.0 mm, or less than about 1.0 mm. Ovality is defined herein as the difference between the maximum diameter and the minimum diameter of the tape. The relatively low ovality of the tube reduces the pressure applied to the fiber optic cables, particularly in the corners of fiber optic bundles that have a rectangular or square configuration. Reducing the pressure applied by the tube to the fiber optic bundles causes a reduction in the signal loss of the individual optic fibers.

Cable 100 may be manufactured by applying tape 104 longitudinally inside a co-extruded tube over ribbon cables 106. As discussed above, tape 104 has properties that cushion ribbon cables 106 at pressure points, such as the corners of the bundle of cables 106. Tape 104 is designed to minimize any buildup of fiber or powder on the extrusion tooling, which reduces downtime and rework.

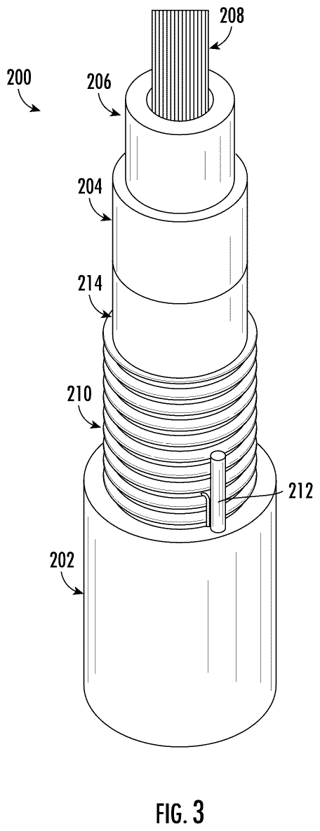

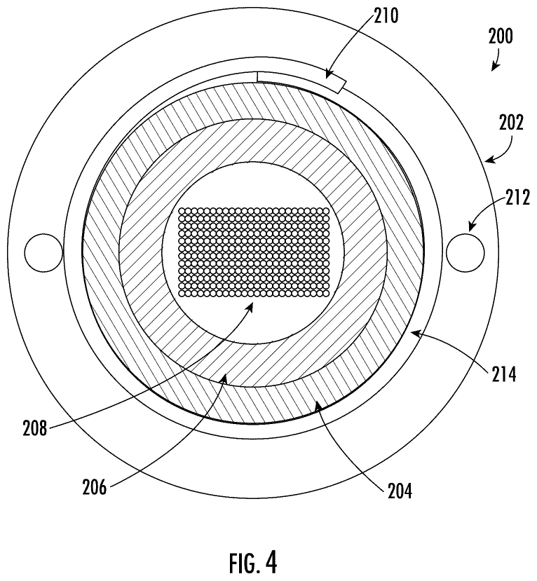

Referring now to FIGS. 3 and 4, a representative fiber optic ribbon cable 200 will now be described. As shown, cable 200 comprises an outer jacket 202, a buffer tube 204, a water swellable tape 206 as described above, and a bundle of fiber optic ribbon cables 208. Jacket 202 and buffer tube 204 may comprise any suitable polymeric material such as, for example, polyethylene, polypropylene, polyvinyl chloride (PVC), polyamides (e.g., nylon), polyester (e.g., PBT), fluorinated plastics (e.g., perfluorethylene propylene, polyvinyl fluoride, or polyvinylidene difluoride), ethylene vinyl acetate (EVA) and combinations thereof. In some embodiments, cable 200 may further include a metal layer 210, such as corrugated steel armor or the like, a ripcord 212 and one or more additional water blocking tapes 214, such as a foam tape or a water swellable tape as described herein.

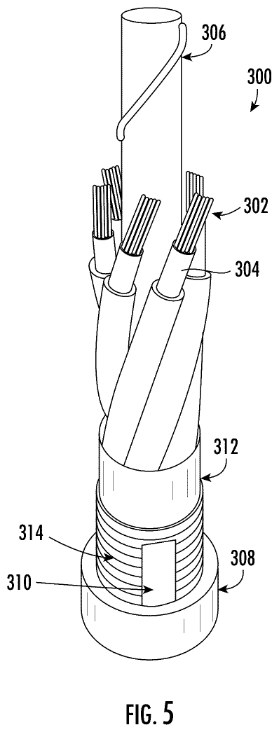

Referring now to FIG. 5, another representative fiber optic ribbon cable 300 generally comprises a plurality of fiber optic bundles 302, which may have any suitable configuration, such as square, rectangular, oval, circular or trapezoidal cross section. In this embodiment, fiber optic bunders 302 are formed into a coil-like configuration (e.g., a helix) to allow cable 300 to bend without placing excessive mechanical stress on the optical fibers during winding, installation, and use. A water swellable tape 304 surrounds each of the bundles 302. Tape 304 comprises any one of the tapes described herein. Cable 300 may further comprise a water blocking yarn 306 in the form of a circular tube that extends inside of the bundles 302 of ribbon cables. Yarn 306 may comprise a water swellable material, such as those described above. Yarn 306 may also be employed to provide strength to the bundles 302 and may comprise any suitable material, such as aramid, fiberglass, or polyester. In some embodiments, cable 300 includes an outer jacket 308, as described above, a metal layer 314, such as corrugated steel armor or the like, a laminated water blocking tape 310 and another general purpose water blocking tape 312, all surrounding the bundle of cables 302 and water swellable tapes 304.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, in a first aspect, a first embodiment is a water swellable tape comprising first and second polymer layers each comprising a nonwoven material having a thickness of about 0.15 mm to about 1 mm and a water swellable layer positioned between the first and second polymer layers.

A second embodiment is the first embodiment, wherein the thickness of each layer is about 0.22 mm to about 0.36 mm.

A third embodiment is any combination of the first two embodiments, wherein the nonwoven material is selected from the group consisting of polyester and nylon.

A 4^{th} embodiment is any combination of the first 3 embodiments, wherein the first and second polymer layers each comprise fibers carded to form a web.

A 5^{th} embodiment is any combination of the first 4 embodiments, further comprising a binder that chemically binds the fibers to each other.

A 6^{th} embodiment is any combination of the first 5 embodiments, wherein the binder comprises a thermoset material.

A 7^{th} embodiment is any combination of the first 6 embodiments, wherein the binder is cross-linked.

An 8^{th} embodiment is any combination of the first 7 embodiments, wherein the fibers are mechanically crimped.

A 9^{th} embodiment is any combination of the first 8 embodiments, wherein the fibers have a linear density of about 0.5 Denier to about 2.0 Denier.

A 10^{th} embodiment is any combination of the first 9 embodiments, wherein the fibers have a length of about 30 mm to about 50 mm.

An 11^{th} embodiment is any combination of the first 10 embodiments, further comprising an adhesive in contact with the first and second polymer layers.

A 12^{th} embodiment is any combination of the first 11 embodiments, wherein the adhesive comprises a water soluble adhesive.

A 13^{th} embodiment is any combination of the first 12 embodiments, wherein the water soluble adhesive comprises polyethylene oxide.

A 14^{th} embodiment is any combination of the first 13 embodiments, wherein the water swellable layer comprises water absorbent particles.

A 15^{th} embodiment is any combination of the first 14 embodiments, wherein the water absorbent particles have a maximum dimension of less than about 160 microns.

A 16^{th} embodiment is any combination of the first 15 embodiments, wherein the maximum dimension is about 75 microns to about 160 microns.

A 17^{th} embodiment is any combination of the first 16 embodiments, wherein the water absorbent particles have a substantially smooth outer surface formed from a suspension polymerization.

An 18^{th} embodiment is any combination of the first 17 embodiments, wherein the water absorbent particles are spherical.

In another aspect, a first embodiment is a cable is comprising the tape of any of the above 18 embodiments.

A second embodiment is the first embodiment, further comprising a plurality of optical fibers, wherein the tape substantially surrounds the optical fibers.

In another aspect, a first embodiment is a fiber optic ribbon cable comprising the tape of any of the above 18 embodiments.

A second embodiment is the first embodiment, wherein the tape contacts at least one of the optical fibers.

A third embodiment is any combination of the first 2 embodiments, further comprising an outer jacket substantially surrounding the tape.

In another aspect, a first embodiment is a water swellable tape comprising first and second polymer layers each comprising nonwoven fibers carded to form a web, wherein the fibers are chemically bound to each other; and a water swellable layer positioned between the first and second polymer layers.

A second embodiment is the first embodiment, wherein each of the polymer layers have a thickness of about 0.15 mm to about 1 mm.

A third embodiment is any combination of the first two embodiments, wherein the thickness is about 0.22 mm to about 0.36 mm.

A 4^{th} embodiment is any combination of the first 3 embodiments, wherein the nonwoven material is selected from the group consisting of polyester and nylon.

A 5^{th} embodiment is any combination of the first 4 embodiments, further comprising a binder that chemically binds the fibers to each other.

A 6^{th} embodiment is any combination of the first 5 embodiments, wherein the binder comprises a thermoset material.

A 7^{th} embodiment is any combination of the first 6 embodiments, wherein the binder is cross-linked.

An 8^{th} embodiment is any combination of the first 7 embodiments, wherein the fibers are mechanically crimped.

A 9^{th} embodiment is any combination of the first 8 embodiments, wherein the fibers have a linear density of about 0.5 Denier to about 2.0 Denier.

A 10^{th} embodiment is any combination of the first 9 embodiments, wherein the fibers have a length of about 30 mm to about 50 mm.

An 11^{th} embodiment is any combination of the first 10 embodiments, further comprising an adhesive in contact with the first and second polymer layers.

A 12^{th} embodiment is any combination of the first 11 embodiments, wherein the adhesive comprises a water soluble adhesive.

A 13^{th} embodiment is any combination of the first 12 embodiments, wherein the water soluble adhesive comprises polyethylene oxide.

A 14^{th} embodiment is any combination of the first 13 embodiments, wherein the water swellable layer comprises water absorbent particles.

A 15^{th} embodiment is any combination of the first 14 embodiments, wherein the water absorbent particles have a maximum dimension of less than about 160 microns.

A 16^{th} embodiment is any combination of the first 15 embodiments, wherein the maximum dimension is about 75 microns to about 160 microns.

A 17^{th} embodiment is any combination of the first 16 embodiments, wherein the water absorbent particles have a substantially smooth outer surface formed from a suspension polymerization.

An 18^{th} embodiment is any combination of the first 17 embodiments, wherein the water absorbent particles are spherical.

In another aspect, a first embodiment is a cable is comprising the tape of any of the above 18 embodiments.

A second embodiment is the first embodiment, further comprising a plurality of optical fibers, wherein the tape substantially surrounds the optical fibers.

In another aspect, a first embodiment is a fiber optic ribbon cable comprising the tape of any of the above 18 embodiments.

A second embodiment is the first embodiment, wherein the tape contacts at least one of the optical fibers.

A third embodiment is any combination of the first 2 embodiments, further comprising an outer jacket substantially surrounding the tape.

In another aspect, a first embodiment is a water swellable tape for use with a fiber optic cable comprising: first and second polymer layers; a water swellable layer positioned between the first and second polymer layers; and a polyethylene oxide adhesive in contact with the first and second polymer layers.

A second embodiment is the first embodiment, wherein the polyethylene oxide adhesive bonds the first polymer layer to the second polymer layer.

A third embodiment is any combination of the first 2 embodiments, wherein the first polymer layer comprises a nonwoven polyester material.

A 4^{th} embodiment is any combination of the first 3 embodiments, wherein the second polymer layer comprises a nonwoven polyester material.

A 5^{th} embodiment is any combination of the first 4 embodiments, wherein the first and second polymer layers comprise a chemical binder.

A 6^{th} embodiment is any combination of the first 5 embodiments, wherein the chemical binder comprises a thermoset material.

A 7^{th} embodiment is any combination of the first 6 embodiments, wherein the first and second polymers layers each have a thickness of about 0.15 mm to about 1.0 mm.

An 8^{th} embodiment is any combination of the first 7 embodiments, wherein the thickness is about 0.22 mm to about 0.36 mm.

A 9^{th} embodiment is any combination of the first 8 embodiments, wherein the water swellable layer comprises water absorbent particles.

What is claimed is:

1. A water swellable tape comprising:
first and second polymer layers, the polymer layers each comprising a nonwoven material having a thickness of about 0.15 mm to about 1 mm; and
a water swellable layer positioned between the first and second polymer layers.

2. The tape of claim 1, wherein the thickness is about 0.22 mm to about 0.36 mm.

3. The tape of claim 1, wherein the nonwoven material has an area density of about 30 g/m² to about 50 g/m².

4. The tape of claim 3, wherein the area density is about 39 g/m² to about 45 g/m².

5. The tape of claim 1, wherein the nonwoven material is selected from the group consisting of polyester and nylon.

6. The tape of claim 1, wherein the first and second polymer layers each comprise fibers carded to form a web.

7. The tape of claim 6, further comprising a binder that chemically binds the fibers to each other.

8. The tape of claim 6, wherein the fibers have a linear density of about 0.5 Denier to about 2.0 Denier.

9. The tape of claim 6, wherein the fibers have a length of about 30 mm to about 50 mm.

10. The tape of claim 1, further comprising a water soluble adhesive in contact with the first and second polymer layers.

11. The tape of claim 10, wherein the water soluble adhesive comprises a material selected from the group consisting of starch, dextrin, acrylic, polychloroprene, animal or vegetable glues, polyurethane, polymer acetates, such as polyvinyl acetate (PVA), polyethylene oxide (PEO), and ethylene vinyl acetate (EVA), latex, elastomers, rubbers and combinations thereof.

12. The tape of claim 1, wherein the water swellable layer comprises water absorbent particles having a maximum dimension of less than about 160 microns.

13. A fiber optic ribbon cable comprising the tape of claim 1.

14. A water swellable tape comprising:
first and second polymer layers, the polymer layers each comprise nonwoven fibers carded to form a web, wherein the fibers are chemically bound to each other; and
a water swellable layer positioned between the first and second polymer layers.

15. The tape of claim 14, wherein each of the polymer layers havs a thickness of about 0.15 mm to about 1 mm.

16. The tape of claim 14, wherein the nonwoven material is selected from the group consisting of polyester and nylon.

17. The tape of claim 14, further comprising a binder that chemically binds the fibers to each other.

18. The tape of claim 14, wherein the fibers have a linear density of about 0.5 Denier to about 2.0 Denier.

19. The tape of claim 14, further comprising a water soluble adhesive in contact with the first and second polymer layers.

20. The tape of claim 19, wherein the water soluble adhesive comprises a material selected from the group consisting of starch, dextrin, acrylic, polychloroprene, animal or vegetable glues, polyurethane, polymer acetates, such as polyvinyl acetate (PVA), polyethylene oxide (PEO), and ethylene vinyl acetate (EVA), latex, elastomers, rubbers and combinations thereof.
